(19) United States
(12) Patent Application Publication
(10) Pub. No.: US 2020/0193031 A1
(43) Pub. Date: Jun. 18, 2020

(54) System and Method for an Automated Analysis of Operating System Samples, Crashes and Vulnerability Reproduction

(71) Applicant: ZecOps, San Francisco, CA (US)

(72) Inventors: Itzhak Avraham, San Francisco, CA (US); Taly Slachevsky, San Francisco, CA (US); Omer Deutscher, Yavne (IL); Yaniv Karta, San Francisco, CA (US); Nir Avraham, Yavne (IL)

(73) Assignee: ZecOps, San Francisco, CA (US)

(21) Appl. No.: 16/718,058

(22) Filed: Dec. 17, 2019

Related U.S. Application Data
(60) Provisional application No. 62/780,920, filed on Dec. 17, 2018.

(51) Int. Cl. G06F 21/57; G06F 21/56

(52) U.S. Cl. CPC G06F 21/577; G06F 2221/034; G06F 21/566

(57) ABSTRACT

Malware analysis and root-cause analysis, and information security insights based on Operating System sampled data. Sampled data includes structured logs, Operating System Snapshots, programs and/or processes and/or kernel crashes, crash dumps, memory dumps, stackshots, simulated crashes or samples. The sampled data contains payload for extraction for the purpose of detection, evaluation and reproduction of threats, infection vector, threat actors and persistence methods in the form of backdoors or Trojans or exploitable vulnerabilities used for initial infiltration or lateral movement.

### CROSS REFERENCE TO RELATED APPLICATIONS

This application claims the benefit of U.S. Provisional Application No. 62/780,920 filed on Dec. 17, 2018, the contents of which are incorporated by reference herein.

### FIELD OF THE INVENTION

The present invention relates to malware analysis and root-cause analysis, and information security insights based on Operating System sampled data such as structured logs, Operating System Snapshots, programs and/or processes and/or kernel crashes, crash dumps, memory dumps, stackshots, simulated crashes or samples containing payload for extraction for the purpose of detection. evaluation and reproduction of threats, infection vector, threat actors and persistence methods in the form of backdoors or Trojans or exploitable vulnerabilities used for initial infiltration or lateral movement.

### BACKGROUND

A cyber-attack is any type of offensive maneuver that targets computer information systems, infrastructures, computer networks, personal computer, mobile device or embedded devices. A cyber-attack may steal, alter, or destroy a specified target by hacking into a susceptible system. Cyber-attackers often attempt to digitally infect an organization and may remain persistent by deploying its payload in a form of installing a backdoor or any sort of Remote Access Trojan in multiple endpoints, servers or various smart devices (e.g., smartphones, tablets, Set Top Boxes, smart-watches, etc.). As an example, to achieve such persistency, cyber-attackers, or threat actors, may send multiple emails within an organization in order to infect various targets in multiple locations of the organization's network, spread laterally via the network, base stations, air inputs such as WiFi, Bluetooth, or by providing, an unexpected input to a client side application. An extraction method then selectively reduces the amount of data to be processed and reduces the sensitive private information that may be included within data streams. Prior art suggest various methods for categorization and automatic partitioning of the collected features and traits from the data.

There exists a need in the art to automatically determine cyber-attack, or exploit types, using automated or manual analysis.

### BRIEF SUMMARY OF THE INVENTION

The methods and systems described herein provide information security insights based on sampled data from Operation Systems. Sampled data may include, but is not limited to structured logs, Operating System Snapshots, programs and/or processes and/or kernel crash dumps, memory dumps, stackshots, simulated crashes, or samples containing payload for extraction for the purpose of detection and evaluation and reproduction of threats, infection vectors, threat actors and persistence methods in the form of backdoors or Trojans or exploitable vulnerabilities used.

The methods and systems described herein for detection purposes the detection process into at least three stages:
1. Responsible Object (RO)—an entity within the document or a data format
2. Point of Entry (PoE)—Point of exploitation or triggering point, the actual code that exploits the RO
3. Post-Infection—Payload used following a successful exploitation of the PoE.

Each stage may be categorized by a set of features corresponding to existing states correlated to the analysis stage. Each of the stages do not necessarily require all other steps to be valid independently. The sequences relevant for each stage is embodied within.

The methods and systems described herein further sets forth the investigations of files, crashes, stackshots and/or memory dumps for the purpose of payload and root-cause analysis of an incident, and, more particularly, to enumerate the traits correlated to a cyber-attack or a software bug. Further, the present invention also relates to an automated method of extracting suspected components from a file, memory, device or data-stream, including, but not limited to, vulnerabilities, exploits, payloads, and various indicators triggering end-cases to support or facilitate a cyber-attack.

Even further, the present invention relates to optional extraction of information from a data stream, memory dump or a file without including the content of the entire file or data stream. As described herein, automated estimation of the exploit, vulnerability, attack type and/or potential threats is performed in order to indicate if such payload extraction is needed as well as to determine the Responsible Objects or offsets that are likely to contain such payloads.

### BRIEF DESCRIPTION OF THE DRAWINGS

This disclosure is illustrated by way of example and not by way of limitation in the accompanying figure(s). The figure(s) may, alone or in combination, illustrate one or more embodiments of the disclosure. Elements illustrated in the figure(s) are not necessarily drawn to scale. Reference labels may be repeated among the figures to indicate corresponding or analogous elements.

The detailed description makes reference to the accompanying figures in which:

FIG. 1 is a deployment diagram providing schematic view of the system and the responsible components later described in detail for use in accordance with herein described systems and methods;

FIG. 2 is a component diagram describing Crash Dump, Memory Dump and/or Crash Dump Extraction from OS Diagnostics analysis in accordance with at least one embodiment of the disclosed invention;

FIG. 3 is an illustration of categorized unstructured and structured data streams, files and other digital forensics data in accordance with at least one embodiment of the disclosed invention;

FIG. 4 is an illustration of platform and OS trait extraction and identification of responsible objects in accordance with at least one embodiment of the disclosed invention;

FIG. 5 is an illustration of the techniques used to symbolicate and analyze crash logs, memory dumps, stackshots or dumps of processes, applications, SoCs and kernel in accordance with at least one embodiment of the disclosed invention;

FIG. 6 is an illustration of an embodiment of anonymization technology in accordance with at least one embodiment of the disclosed invention;

FIG. 7 is an illustration of another embodiment of anonymization technology in accordance with at least one embodiment of the disclosed invention;

FIG. 8 depicts an online incident dashboard in accordance with at least one embodiment of the disclosed invention;

FIG. 9 illustrates a diagram of an exemplary computing system illustrative of a computing environment in which the herein described systems and methods may operate; and

FIG. 10 is an illustration of a Null Pointer Dereference scenario in accordance with at least one embodiment of the disclosed invention.

### DETAILED DESCRIPTION

The figures and descriptions provided herein may have been simplified to illustrate aspects that are relevant for a clear understanding of the herein described apparatuses, systems, and methods, while eliminating, for the purpose of clarity, other aspects that may be found in typical similar devices, systems, and methods. Those of ordinary skill may thus recognize that other elements and/or operations may be desirable and/or necessary to implement the devices, systems, and methods described herein. Since such elements and operations are known in the art, and because they do not facilitate a better understanding of the present disclosure, for the sake of brevity a discussion of such elements and operations may not be provided herein. The present disclosure is deemed to nevertheless include all such elements, variations, and modifications to the described aspects that would be known to those of ordinary skill in the art.

Embodiments are provided throughout so that this disclosure is sufficiently thorough and fully conveys the scope of the disclosed embodiments to those who are skilled in the art. Numerous specific details are set forth, such as examples of specific components, devices, and methods, to provide a thorough understanding of embodiments of the present disclosure. Nevertheless, it will be apparent to those skilled in the art that certain specific disclosed details need not be employed, and that exemplary embodiments may be embodied in different forms. As such, the exemplary embodiments should not be construed to limit the scope of the disclosure. As referenced above, in some exemplary embodiments, well-known processes, well-known device structures, and well-known technologies may not be described in detail.

The terminology used herein is for the purpose of describing particular exemplary embodiments only and is not intended to be limiting. For example, as used herein, the singular forms “a,” “an,” and “the” may be intended to include the plural forms as well, unless the context clearly indicates otherwise. The terms “comprises,” “comprising,” “including,” and “having” are inclusive and therefore specify the presence of stated features, integers, steps, operations, elements, and/or components, but do not preclude the presence or addition of one or more other features, integers, steps, operations, elements, components, and/or groups thereof. The steps, processes, and operations described herein are not to be construed as necessarily requiring their respective performance in the particular order discussed or illustrated, unless specifically identified as a preferred or required order of performance. It is also to be understood that additional or alternative steps may be employed, in place of or in conjunction with the disclosed aspects.

When an element or layer is referred to as being “on,” “engaged to,” “connected to,” or “coupled to” another element or layer. it may be directly on, engaged. connected or coupled to the other element or layer, or intervening elements or layers may be present, unless clearly indicated otherwise. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). Further, as used herein the term “and/or” includes any and all combinations of one or more of the associated listed items.

Yet further, although the terms first, second, third, etc. may be used herein to describe various elements, components, regions, layers and/or sections, these elements, components, regions, layers and/or sections should not be limited by these terms. These terms may be only used to distinguish one element, component, region, layer or section from another element, component, region, layer or section. Terms such as “first,” “second,” and other numerical terms when used herein do not imply a sequence or order unless clearly indicated by the context. Thus, a first element, component, region, layer or section discussed below could be termed a second element, component, region, layer, or section without departing from the teachings of the exemplary embodiments.

System Overview

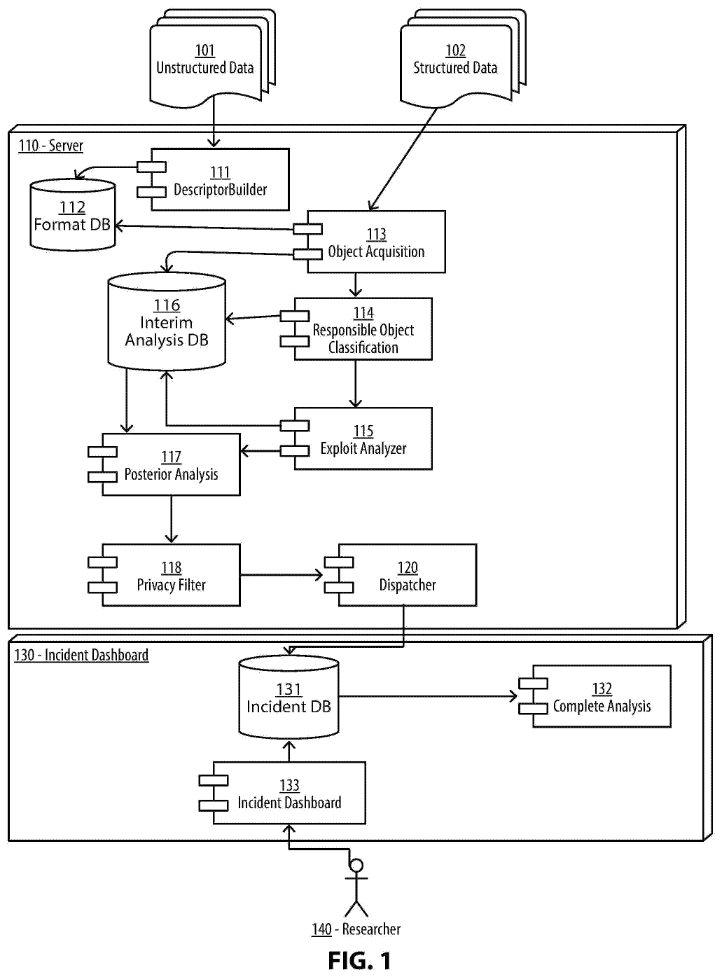

FIG. 1 depicts an exemplary deployment of the system handling unstructured 101 and structured 102 input data streams, used by the Automated analysis server 110. Server 110 may first normalize the unstructured data by dynamically creating descriptors that may be applied using DescriptorBuilder 111. For example, a binary firmware format descriptor may be automatically built given enough examples that exhibits the common use cases. DescriptorBuilder 111 and its interaction with Format DB 112 are described further below.

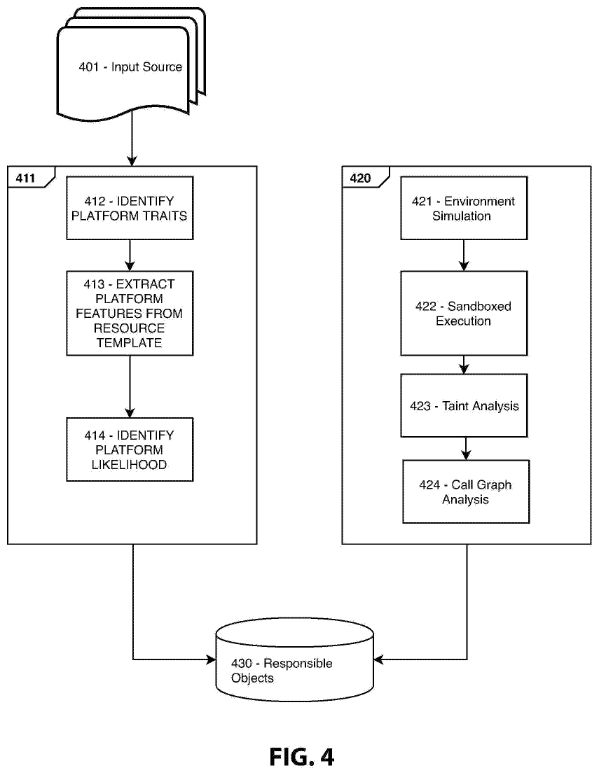

Various Object Acquisition 113 strategies relevant for the data format described on Format DB 112 as a collection of Responsible objects, entities, datapoints which are inserted into an Interim Analysis DB 116 may be used for the Responsible Object Classification process 114. An initial set of verdicts may be generated from the Responsible object classification process 114 and inserted into the Interim Analysis DB 116. An Exploit Analyzer 115 may use various methods such as taint analysis, target simulation, sandboxing, and call graph analysis as described in conjunction with FIG. 4.

At this point, data has been structured and responsible objects have been identified and collected into the Interim Analysis DB 116. The Interim Analysis DB 116 may contain a collection of preconditions that enables the execution, the vulnerable execution flow, and the responsible objects (functions, entry points, syscalls, variables, injected modules, injected code, injected libraries or similar). The Exploit Analyzer 115 is described in detail in conjunction with FIG. 4 on subsystem 420 described later as a preferred embodiment of the current invention. By this stage, the Interim Analysis DB 116 may contain all the information related to an incident. A final stage posterior probability of previously analyzed incidents that correlates to the histogram bin which the current incident belongs to is calculated and stored on a Posterior Analysis 117 DB. This information may prove useful for malware grouping, server and Content Distribution Network (CDN) identification, base lining threat indicators, and trend identification of the incident being investigated.

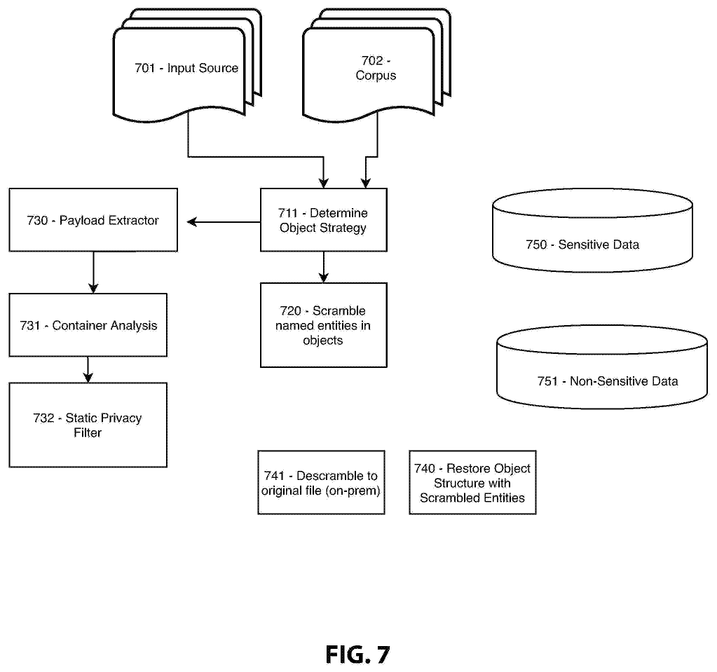

This information is then used by a Privacy Filter 118 to ‘anonymize’ the data. This data is further described in conjunction with FIG. 7. Dispatcher 120 may securely push the incident information from the Interim Analysis DB 116 to a global incident data center, or Incident. Dashboard 130 without sharing any private information from the incident source data collection according to a set of policies that can be defined in accordance to privacy and restricted privacy regulations. Data pushed to Incident Dashboard 130 may be stored upon an Incident DB 131, undergo further processing by Complete Analysis 132, and viewed upon an Incident Dashboard display 133. For example, incident information may be viewed by a Researcher 140. Researcher 140 may be a network engineer, network security consultant, or the like.

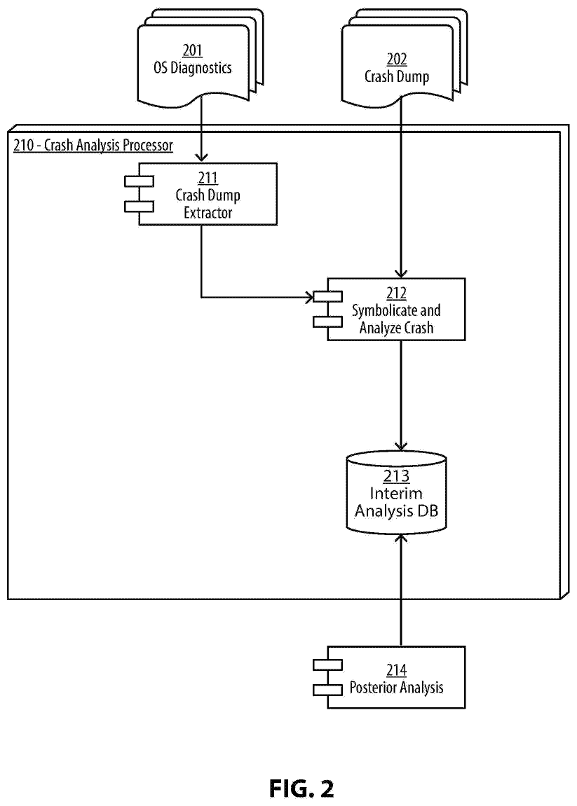

As shown in FIG. 2, similar components described in FIG. 1 may be used in a different context described, within a differing embodiment. FIG. 2 specifically describes different processes required from general input sources.

The input for the system described shown in FIG. 2 may be OS Diagnostics 201, such as Apple®'s sysdiagnose or Microsoft® Windows Error Reporting (WER), Microsoft® Event Viewer, or any Crash Dump 202 from logs of an operating system kernel, or services or applications or firmware. A Crash Dump Extractor 211 may preprocess input data in the diagnostics logs, such as decompressing the logs and matching with relevant crash dumps that can be processed.

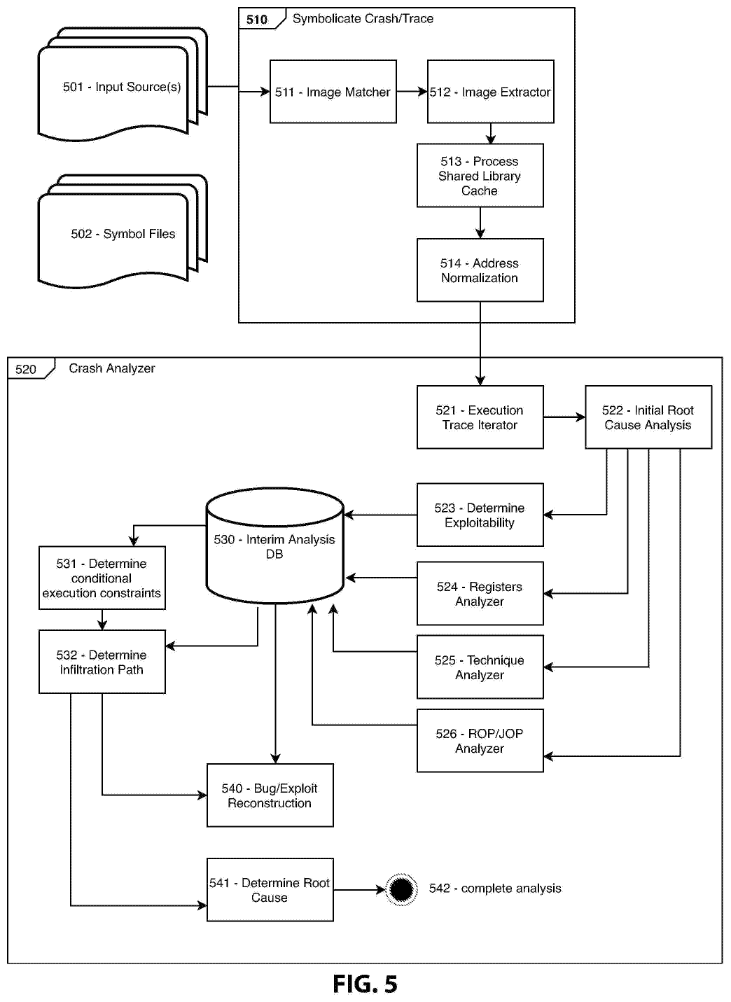

Relevant execution preconditions may be determined in view of the crash analysis and the symbolication process 212. The symbolication and crash analysis process is described in further detail in conjunction with FIG. 5 as a different embodiment of this current invention. The collection of verdicts resulted from the analysis of the symbolicated crashes, such as root cause analysis and conditional execution constraints, may be stored in Interim Analysis DB 213. Similar incidents may be correlated using a Posterior Analysis 230 process in a similar way previously described in conjunction with FIG. 1.

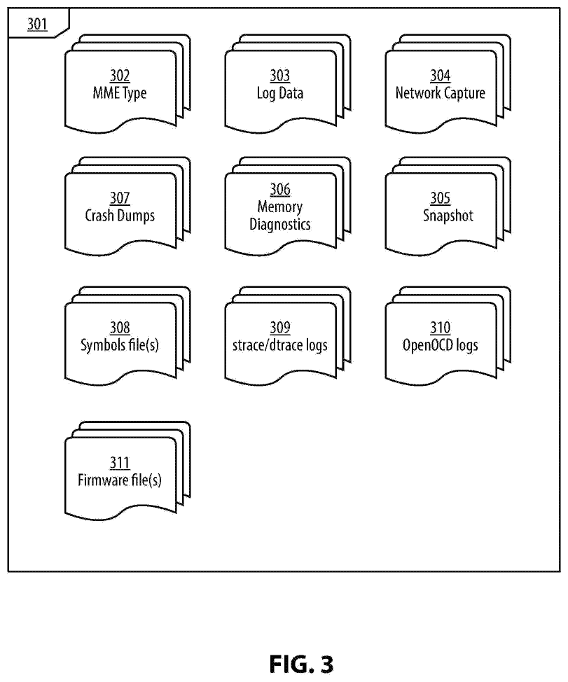

FIG. 3 depicts various types of inputs sources 301 available for the system described in FIG. 1 and FIG. 2 and includes any MIME type 302 corresponding to, for example, RFCs 2045, 2046, 2047, 2048, 2077, 6838 and 4855.

Log data 303 may be formatted as application log data, for example from a database, or server application like a web server, DNS, syslog, or service-based logging data store.

Network Capture 304 may include packet capture data from network interfaces such as Wi-Fi Bluetooth, from the operating system itself, or from an internal operating system on the firmware system on a chip.

Snapshot 305 may include all snapshots files generated using SysDiagnostics or similar programs.

Memory diagnostics 306 may include virtual and physical memory statistics such as pool information, usage information, resource usage, and physical memory image at a given incident state.

Crash Dumps 307 refers to application, operating system kernel, application, process, driver, memory dump or service crash or panic information collected or aggregated within a diagnostics report or extracted from Log Data 303 or OS Diagnostics 312.

Symbols file(s) 308 may include Symbols that may be used to symbolicate/correlate addresses to functions and/or any other debugging information available in the forms of symbols.

Application Debug logs 309 generated using known in the art tools such as strace, Dtrace, and similar utilities.

On-Chip Debugger (OCD) logs 310 may include support for JTAG, Board, Target, Interface, Flash, and Modem.

Firmware Files 311 may include a small file system, raw memory, specific register set, usage statistics, logs and even complete operating system snapshot in a specific state. Firmware files 311 may further include operating system files, flushable files, configuration files, memory snapshots, state snapshots, binary manifestation of network state.

OS Diagnostics 312 may include incidental and environment information, indicating the platform, peripheral devices connected, protocol used and raw information specific to the operating system and the computing platform.

Methods Overview

In an exemplary embodiment, the present invention utilizes an approach for Responsible Object (RO) classification as depicted in FIG. 4. An input source 401 may be fed into the system described earlier as one or more of the types described in FIG. 3. The input source 401 is analyzed in block 411 in steps 412-414 to gather conclusive computing platform and operating system traits. These identifiers may be inferred by attribution of sections from the input source to a logical sequence of instructions that may fit one or more platforms. Methods known in the art such as Burrows-Wheeler Transform (BWT), also known as block-sorting, compression, may be used with a set of plain, encoded or obfuscated instruction sets to evaluate the right computing platform. After identifying the platform traits in step 412, the specific platform features which are relevant to the computing platform are extracted in step 413 according to the most likely similar resource template, resources by nature may be aggregative and contain other resources within. To summarize, the identification process platform likelihood, in step 414, is identified from a set of preselected combinations of supported computing platforms and operating systems according to the matched resource templates, platform traits and accuracy of previous identifications. The environment data collected in this process is stored in the Responsible Objects data storage 430. This data is later used in a process 420 that set, up an environment in step 421 for the selected computing platforms, operating systems, peripheral devices and matching software, applications and hardware versions. The input source 401 may then detonated on a sandboxed execution environment 422 emulating the environment. Other methods known in the art, such as taint analysis 423 may be used to detect complicated attacks such as confused deputy scenarios (not shown) and Call Graph Analysis 424 are later used for classification of responsible object and resulted verdicts. Logs of execution results, affected services, system processes, and kernel dumps, along with the responsible object may then be stored on data storage 430.

FIG. 5. depicts an automated crash symbolication and analysis system. The Symbolicate Crash/Trace system 510 may receive an input source(s) 501 and optionally matched symbol files 502. The input source may then be parsed by the firmware image matcher 511. The relevant firmware image may then be provided to an Image Extractor 512 and processed by a shared library cache 513. The relevant firmware image may then undergo Address Normalization 514 from ASLR to relative address to the relevant library or binary.

The Crash Analyzer system 520 receives a normalized crash with matching symbols traces and propagate an execution crash state 521 for Initial Root Cause Analysis 522. The root cause is determined by determining if the conditions for exploitability are met in step 523. Tampering or anomaly of computing platform registers may be determined in step 524 or an unexpected set of values in a given state. Techniques Analyzer 525 may then used to evaluate which technique was used. ROP/JOP Analyzer 526 may be used to determine if the backtrace contained illegitimate execution provided by the attacker and not by the operating system, application or process that crashed. Additional checks may be made to verify to authenticity of the loaded modules as part of a System Attestation module (not shown). The results may then be stored in the Interim Analysis DB 530. Once the data is stored, the storage triggers the crash analyzer to determine conditional execution constraints (step 531) such as stack cookies, poison and non-poison cookies, stack/heap corruption, null pointer dereference, integer overflow, and heap overflow, or the like. Determine Infiltration Path (step 532) may determine the attack vector, injected code or module, and/or vulnerability and/or bug that triggered the crash. Such inference could lead to a bug, vulnerability or exploit reconstruction (step 540). Determine Infiltration Path (Step 532) may instruct the host either automatically or manually, to provide additional files or memory areas that were either injected or could help to reconstruct the vulnerability in Bug/Exploit Reconstruction (step 540). Further, Exploit Reconstruction 540 may be used to provide insights to a user via the dashboard. API or further analyzed automatically to extract additional insights. Bug/Exploit Reconstruction can then point on the file used in the attack, the injected module in memory, and/or the vulnerability/exploit itself. The attack vector, infiltration path, conditional constraints and data collected in the interim analysis database are then used to determine the root cause (step 541) and provide complete analysis (step 542).

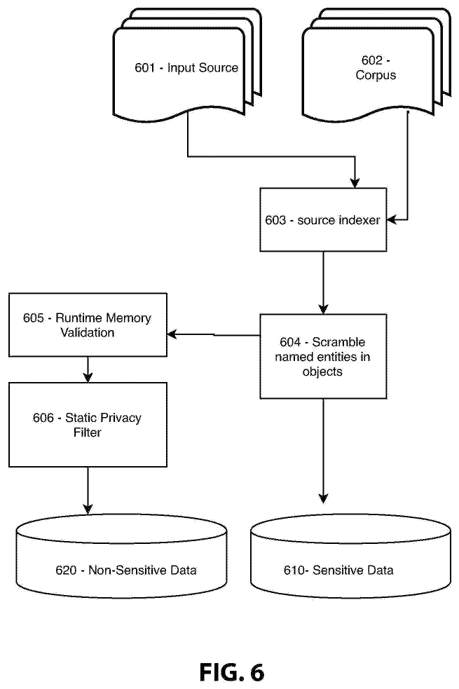

FIG. 6 shows an Automated Baselining System that may receive an Input Source 601 described above in connection with FIG. 3 and a Corpus 602, the corpus built using named entities corresponding to contextual patterns of appearance in methods known in the art in the field of Natural Language Processing as Named Entity Recognition (NER). The additional Named Entities defined by the system can be sub-categories of existing named entities such as user names (person), passwords, location, and/or unique device identifiers. In the field of natural language processing, part of speech tagging process specially trained to fit the Input source type would accelerate the construction of each dynamic corpus 602. Collecting index points based on part of speech tagging of the input source and matching it with the corpus graphs to identify the indexes of the novel entities defined above. Other corpus could be provided by the user. The Input Source and the Corpus are later sorted in the Source Indexer 603, and transformed into new objects in Scramble Named Entities in Objects (step 604). The key to each transformed object may be later saved in the Sensitive Data database 610. Once the static scrambling is completed in step 604—dynamic check may be later performed to determine if sensitive data appears once running the executable, binary, script or data source dynamically. The Runtime Memory Validator 605 may perform various checks, simulations and/or emulations, in order to determine if any sensitive data, appears in runtime, in the memory, or after de-obfuscation, decryption, or as part of additional configuration or data received from a remote server. Once the tests are performed, they are compared against a Static Privacy Filter 606 to determine that there is no sensitive data contained in the input. Once all the static privacy filters passed, the data may then be stored in the Non-Sensitive Data database 620.

FIG. 7 is an illustration of another embodiment of anonymization technology. FIG. 7 includes an input source 701 and a Corpus 702. An object strategy is determined in step 711. Step 720 scrambles named entities in objects. A payload extractor is shown in step 730. Container analysis is performed in step 731. A static privacy filter may be applied in step 732. Alternative steps may include a descramble to original file in step 741 and restore object structure with scrambled entities in step 740. Sensitive data may be stored in database 750; non-sensitive data may be stored in database 751.

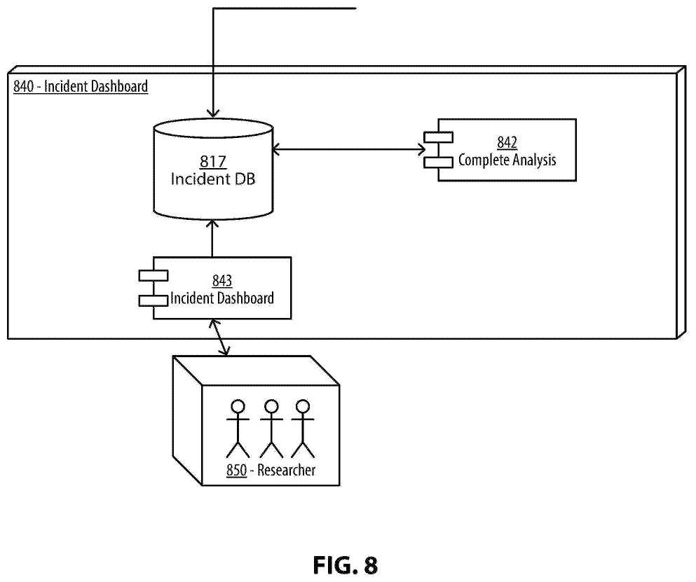

FIG. 8 depicts an online incident dashboard system 840 in accordance with at least one embodiment of the disclosed invention. The dashboard may include a database 817 connected to an analysis module 842. The dashboard may be displayed on a display 843 to one or more researchers 850.

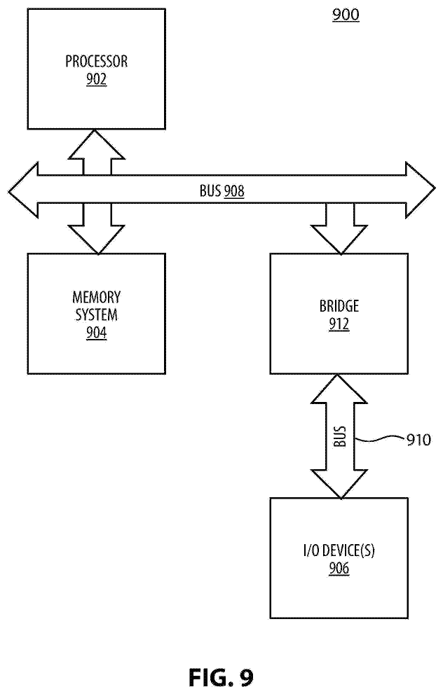

FIG. 9 is an example of a simplified functional block diagram of a computer system 900. The functional descriptions of the present invention can be implemented in hardware, software or some combination thereof.

As shown in FIG. 9, the computer system 900 includes a processor 902, a memory system 904 and one or more input/output (I/O) devices 906 in communication, by a communication ‘fabric’. The communication fabric can be implemented in a variety of ways and may include one or more computer buses 908, 910 and/or bridge and/or router devices 912 as shown in FIG. 9. The I/O devices 906 can include network adapters and/or mass storage devices from which the computer system 900 can send and receive data for generating and transmitting advertisements with endorsements and associated news. The computer system 900 may be in communication with the Internet via the I/O devices 908.

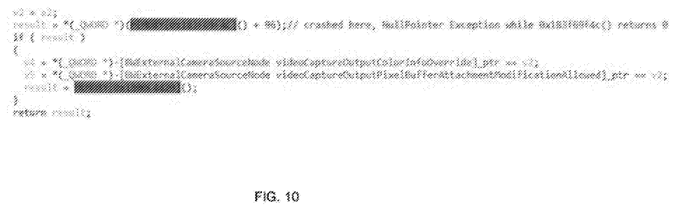

FIG. 10 is an illustration of a Null Pointer Dereference scenario, where the crash is not necessarily exploitable and caused by a programmatic error instead of malicious intent in accordance with at least one embodiment of the disclosed invention.

Those of ordinary skill in the art will recognize that many modifications and variations of the present invention may be implemented without departing from the spirit or scope of the invention. Thus, it is intended that the present invention cover the modification and variations of this invention provided they come within the scope of the appended claims and their equivalents.

The various illustrative logics, logical blocks, modules, and engines, described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Further, the steps and/or actions of a method or algorithm described in connection with the aspects disclosed herein may be embodied, directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of instructions on a machine readable medium and/or computer readable medium.

It is appreciated that exemplary computing system 900 is merely illustrative of a computing environment in which the herein described systems and methods may operate, and thus does not limit the implementation of the herein described systems and methods in computing environments having differing components and configurations. That is, the inventive concepts described herein may be implemented in various computing environments using various components and configurations.

Those of skill in the art will appreciate that the herein described apparatuses, engines, devices, systems and methods are susceptible to various modifications and alternative constructions. There is no intention to limit the scope of the invention to the specific constructions described herein. Rather, the herein described systems and methods are intended to cover all modifications, alternative constructions, and equivalents falling within the scope and spirit of the disclosure, any appended claims and any equivalents thereto.

In the foregoing detailed description, it may be that various features are grouped together in individual embodiments for the purpose of brevity in the disclosure. This method of disclosure is not to be interpreted as reflecting an intention that any subsequently claimed embodiments require more features than are expressly recited.

Further, the descriptions of the disclosure are provided to enable any person skilled in the art to make or use the disclosed embodiments. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but rather is to be accorded the widest scope consistent with the principles and novel features disclosed herein.

1. A computer-implemented method for the automated analysis of operating system samples, the samples containing payload for extraction for the purpose of detection, evaluation and reproduction of threats, infection vector, threat actors and persistence methods in the form of backdoors or Trojans or exploitable vulnerabilities used for initial infiltration or lateral movement.
